(19) United States
(12) Patent Application Publication
(10) Pub. No.: US 2022/0048731 A1
(43) Pub. Date: Feb. 17, 2022

(54) SAFETY LOCKOUT ON PATHS TO REGIONS OF HEIGHTENED RISK

(71) Applicant: Elevator Industry Work Preservation Fund, Columbia, MD (US)

(72) Inventor: H. Scott Russell, Columbia, MD (US)

(73) Assignee: Elevator Industry Work Preservation Fund, Columbia, MD (US)

(21) Appl. No.: 16/992,843

(22) Filed: Aug. 13, 2020

(51) Int. Cl. B66B 1/34; B66B 5/00; F16P 3/14

(52) U.S. Cl. CPC B66B 1/3423; B66B 5/0087; F16P 3/144; B66B 5/0012; B66B 1/3446; B66B 5/0056

(57) ABSTRACT

A safety device for a path that is traversed to enter a region in which danger to an individual is heightened due to operation of a machine includes at least one sensor installed along the path so as to detect the individual thereat, which compels the sensor to generate a signal. A lockout mechanism is deployed that compels the machine into a non-operational state in response to receiving the signal from the sensor. The lockout mechanism ensures the machine remains in the non-operational state when the signal from the sensor is removed therefrom. A reset circuit is deployed that, in response to activation thereof, compels the lockout mechanism to allow the machine into the operational state from the non-operational state.

### BACKGROUND

An elevator pit is the lowest region within an elevator shaft or hoistway and typically provides clearance for operational components of the elevator that are positioned below the elevator car. To enter the pit, such as for maintenance procedures, the elevator car is moved to a higher landing, the lowest landing elevator doors are opened, and workers enter the pit through the opened elevator doors using a pit ladder, which is typically mounted to the elevator shaft wall.

Space-conscious building designers typically make elevator pits as small as possible and, in many applications, there is not sufficient space for an operator to work in the pit when the elevator car is at its bottom landing. When so implemented, elevator pits can be very dangerous places to work and elevator pit ladders define paths to regions of heightened risk to personnel. To provide a level of safety, a lockout technique may be employed by which certain elevator features are prohibited from activating, such as movement of the elevator car, in response to the lockout being activated. Techniques for making elevator pit work more safe is an ongoing effort.

### SUMMARY

A safety device for a path that is traversed to enter a region in which danger to an individual is heightened due to operation of a machine includes at least one sensor installed along the path to detect the individual thereat, which compels the sensor to generate a signal. A lockout mechanism is deployed that compels the machine into a non-operational state in response to receiving the signal from the sensor. The lockout mechanism ensures the machine remains in the non-operational state when the signal from the sensor is removed therefrom. A reset circuit is deployed that, in response to activation thereof, compels the lockout mechanism to allow the machine into the operational state from the non-operational state.

### BRIEF DESCRIPTION OF THE DRAWINGS

FIG. 1 is a schematic diagram of an example elevator system embodying the concepts described in this disclosure

FIGS. 2A-2B are illustrations of an example elevator pit ladder suitable for embodying the principles described herein.

FIG. 3 is an illustration of a portion of an elevator pit ladder at which a proximity switch that indicates whether a ladder cover is closed.

FIG. 4 is an illustration of a close-up view of an example weight activation mechanisms, i.e., pressure-sensitive strips and weight-activated switch, that may be used in conjunction with embodiments of the principles described herein.

FIG. 5 is an illustration of a close-up view an example weigh-activated switch that may be used in conjunction with embodiments of the principles described herein.

### DETAILED DESCRIPTION

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments. Particular quality or fitness of the examples indicated herein as exemplary is neither intended nor should be inferred.

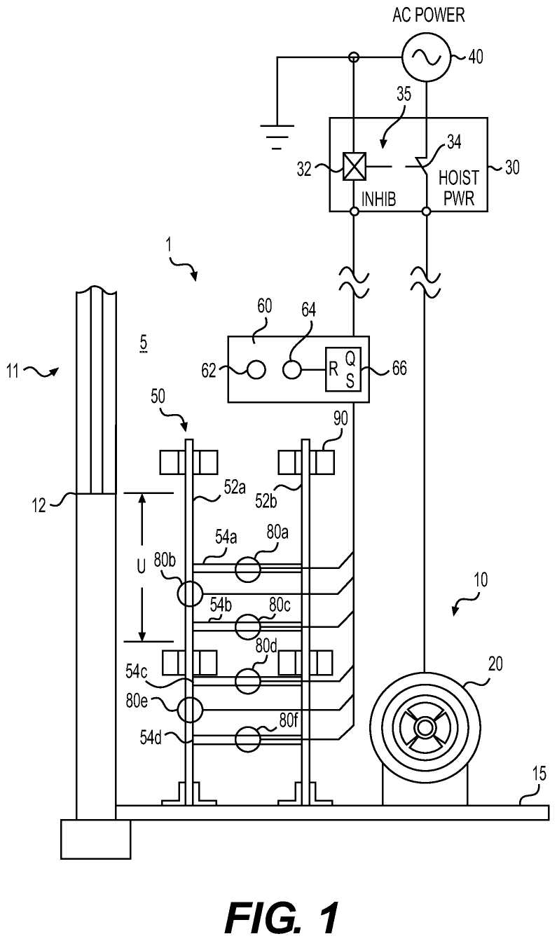

FIG. 1 is a schematic diagram of an exemplary elevator system embodying concepts described in this disclosure. It is to be understood that the elevator system configuration illustrated in FIG. 1, while aptly illustrative of key principles of the inventive concepts, is not the only system configuration that would find benefit in implementing the inventive concepts. Indeed, it is anticipated that, upon review of this disclosure, those having skill in the art will recognize other applications on which the principles described herein may be practiced without departing from the spirit and intended scope thereof.

The environment of FIG. 1 may be that of an elevator pit 10, which is the lowest region of an elevator hoistway 1 and is measured from the hoistway floor 15 to a prescribed distance U below the sill line 12 of the hoistway opening 11 for the lowest floor that is served by that elevator. Distance U varies by application, construction, convention, etc., and may be zero (0). In some applications, for example, the distance U accounts for everything under an elevator cab when that elevator cab is parked in hoistway 1 at the lowest floor that is served by that elevator.

Access to elevator pit 10 may be afforded by elevator pit ladder 50, which defines a path from a relatively safe region, e.g., the hallway of the lowest floor that is served by the elevator, into a region of heightened risk, e.g., elevator pit 10. In the example illustrated, elevator pit ladder 50 is anchored to a wall 5 of hoistway 1 as well to hoistway floor 15 by suitable anchors, representatively illustrated at anchor 90. Given this customary configuration, the “lower” end of elevator pit ladder 50 is that closest to, and indeed may be anchored to, hoistway floor 15. The “upper” end of elevator pit ladder 50 is that opposite to the lower end and may be the end at which a worker mounts elevator pit ladder 50 to traverse the path defined thereby to hoistway floor 15. For convenience, the “up” direction, when used herein, refers to that directed away from the lower end of elevator pit ladder 50 and towards the upper end thereof, while the “down” direction refers to that directed away from the upper end of elevator pit ladder 50 and towards the lower end thereof.

Elevator pit ladder 50 may comprise a pair of stiles 52a-52b, representatively referred to herein as stile(s) 52, that support one or more rungs 54a-54d, representatively referred to herein as rung(s) 54. The stiles 52 and rungs 54 define a path into elevator pit 10 from the relative safety of the building hallway. According to the principles advanced herein, such path can be equipped with safety lockout device(s) to ensure that by the time the worker has traversed the path, prescribed safety protocols, e.g., removal of power to the elevator, are met for working in the region of heightened risk, e.g., elevator pit 10. Skilled safety artisans will recognize other path configurations, e.g., stairs, for which benefits of the principles described herein can be attained without departing from the spirit and intended scope of inventive concepts conveyed hereby.

In one exemplary embodiment, one or more sensors 80a-80f, representatively referred to herein as sensor(s) 80, may be installed on stiles 52 and/or rungs 54 to detect activity on or about elevator pit ladder 50. In one scheme, detection of such activity may trigger activation of a safety lockout, i.e., a mechanism that inhibits operation of a machine that poses elevated risk to personnel in a prescribed region while such personnel are in such region. In the illustrated example, sensors 80, when activated, may generate signals that indicate activity on or about elevator pit ladder 50. Such signals may be conveyed to a local elevator inhibit device 60 by which a power source 40 is decoupled from hoist motor 20. In this example, decoupling power source 40 from hoist motor 20 effectively renders the elevator inoperative and the risk to personnel in elevator pit 10 is reduced. In another example, the elevator inhibit device 60 may be configured to remove power from a brake and drive machine via the power source 40.

As depicted in FIG. 1, elevator inhibit device 60 may include indicator circuitry, representatively illustrated at indicator 62, reset circuitry, representatively illustrated at reset switch 64, and state machine 66. State machine 66 may track an internal safety state that is, for example, a logical one (1) when a signal from any one of the sensors 80 is generated and is logical zero (0) for normal elevator operations. In one embodiment, state machine 66 may be implemented by a set/reset flip-flop or similar circuitry that is “set” responsive to any sensor 80 being activated and “reset” responsive to reset switch 64 being activated. In certain embodiments, reset switch 64 is the only mechanism by which the elevator is returned to normal operation subsequent to a safety event (i.e., an event that sets state machine 66 to logical one (1) state) occurring. This feature of the inventive concept described herein promotes greater safety in that the elevator will remain inoperative as long as the safety state is active, even if other lockout devices are returned to their respective configurations for normal operation. In certain embodiments, return to normal elevator operation is achieved only if an operator activates reset switch 64. Although the reset switch 64 is shown as being disposed on the elevator pit ladder 50, it may be desirable to locate the reset switch 64 and the elevator inhibit device 60 in the aforementioned safe region, such as an exterior machine control room. The reset switch 64 may also be located in the elevator pit 11 and within reach from the safe region, such as from the building hallway.

An elevator inhibit relay 35, comprising relay coil 32 and relay contacts 34 (or other electrical means), may be activated via an output of state machine 66 driving the INHIB terminal of an example elevator control panel 30. The elevator control panel 30 may be incorporated as part of a larger elevator controller, for example in the machine control room. In the illustrated configuration of FIG. 1, whenever one of the sensors 80 indicates activity on or about elevator pit ladder 50, power source 40 is removed from hoist motor 20 through opening of contacts 34. That is, when a safety event occurs, such as when one of sensors 80 is activated, state machine 66 transitions to a logical one (1) state which is conveyed on a signal to relay coil 32 of elevator inhibit relay 35, responsive to which relay contacts 34 open to separate hoist motor 20 from its power source 40.

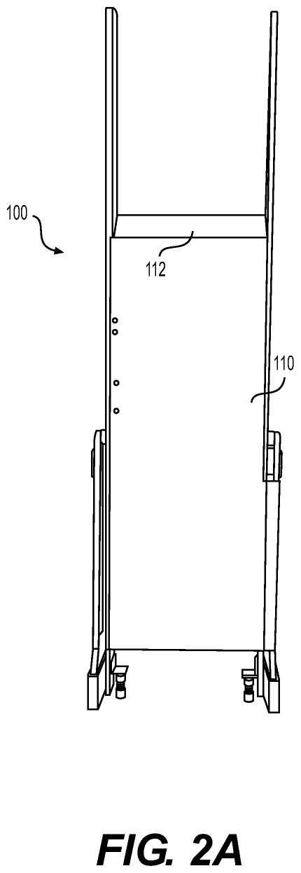

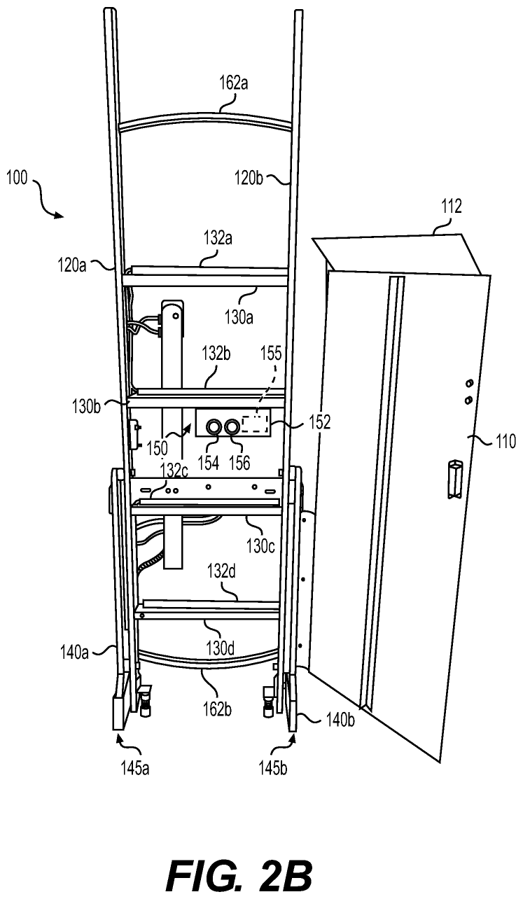

FIGS. 2A-2B, collectively referred to herein as FIG. 2, are illustrations of an example elevator pit ladder 100 suitable for embodying the principles described herein. FIG. 2A is an illustration of elevator pit ladder 100 with an exemplary cover 110 closed and FIG. 2B is an illustration of elevator pit ladder 100 with exemplary cover 110 opened. Cover 110 may be deployed to prohibit ladder use unless the cover is opened, as well as to keep the ladder free of debris. In certain embodiments, cover 110 may have an inwardly-directed flap 112 formed thereon that prevents access to elevator pit ladder operation while cover 110 is closed. Here, the “inward” direction is towards the wall on which elevator pit ladder 100 is mounted (e.g., hoistway wall 5 in FIG. 1).

As is depicted in FIG. 2B, elevator pit ladder 100 may comprise a pair of stiles 120a-120b, representatively referred to herein as stile(s) 120, that support a number of rungs 130a-130d, representatively referred to herein as rung(s) 130 as well as cover 110. The inventive concept described herein is not limited to the manner in which rungs 130 or cover 110 are mechanically supported by stiles 120; any of a number of known techniques may be used in conjunction with embodiments of the present inventive concept without departing from the spirit and intended scope thereof.

Elevator pit ladder 100 may include one or more sensors that drive a tracked state into a value that determines whether the elevator can operate. Prevention of such elevator operation may be achieved in any number of ways, including interposing an inline switching device, such as elevator inhibit relay 35 described above with reference to FIG. 1, in the elevator operating power line, where the elevator inhibit relay 35 is operable between on/off configurations based on the value of the safety state. In other embodiments, preventing elevator operation may be achieved by conveying the safety state to a signaling interface provided by a particular elevator manufacturer and using existing inhibit circuitry to prevent elevator operation while a worker is in the elevator pit. Either of these methodologies may be implemented to embody the principles described herein; ultimately the value of the safety state determines whether power is delivered to/removed from mechanisms by which the elevator car moves in the hoistway.

As illustrated in FIG. 2B, elevator inhibit device 150, which may perform substantially equivalently to inhibit device 60 in FIG. 1, may include an indicator lamp 156 and a reset switch 154 disposed on a housing 152 that encloses an elevator inhibit relay 155. Indicator lamp 156 may indicate the safety state, which is tracked in the open/closed state of elevator inhibit relay 155, which determines whether the elevator itself is in an operational state or a non-operational state. That is, in the example illustrated, elevator inhibit relay 155 combines functionality of state machine 66 and elevator inhibit relay 35; the safety state is tracked by the open/close state of elevator inhibit relay 155 and power is supplied and removed through contacts (not illustrated) of elevator inhibit relay 155. Once the elevator is in a non-operational state, such as in response to a worker being detected in engagement with elevator pit ladder 100, it can be returned to an operational state only after reset switch 154 is activated by a user is the safe region, such as in the machine control room. The elevator inhibit device 150 may also be disposed in the pit with the reset switch 64 as prescribed by code ASME A17.1.

Several electrical protective device mechanisms are illustrated as being implemented with elevator pit ladder 100, any one of which may be deployed independently of deployment of other electrical protective device mechanisms. Here, an “electrical protective device” is a device that prevents machine operation while some condition exists. Thus, an electrical protective device in the illustrated embodiments includes a sensor to determine whether the condition exists (e.g., a worker is on or about to be on the elevator pit ladder 100) and elevator inhibit relay 155 to prevent elevator operation while the condition exists.

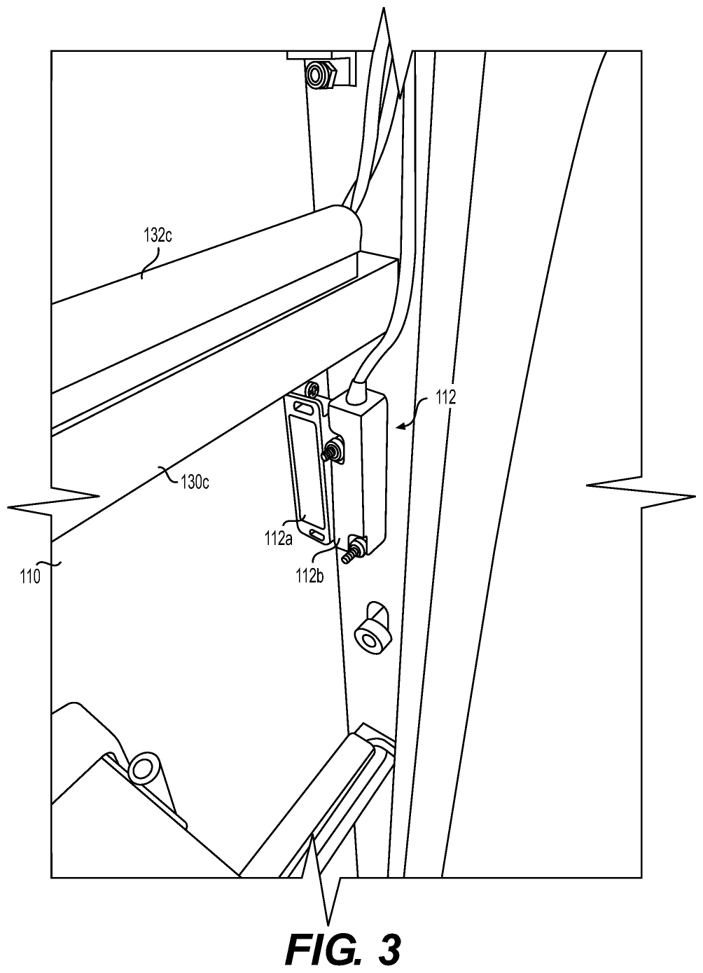

Elevator pit ladder 100 may implement a cover electrical protective device that generates a signal when cover 110 is opened, and then uses that signal to provoke a change in state in elevator inhibit relay 155 within elevator inhibit device 150. FIG. 3 is an illustration of a portion of elevator pit ladder 100 including a proximity switch 112 (sensor) that indicates whether its constituent half-components 112a and 112b are in proximity to one another. When the cover is closed, the two half-components 112a and 112b are in proximity and the sensor outputs a corresponding cover closed signal (e.g., logical zero). When the cover is open, the two half-components of proximity switch 112 are separated and the sensor generates a corresponding cover opened signal (e.g., logical one). The elevator may transition into a non-operational state in response to the cover opened signal, which prohibits operation of the elevator in response to cover 110 being opened. The non-operational state may be indicated on indicator lamp 154 and is removed (or returned to an operational state) only when manually reset, i.e., by a worker depressing reset switch 154.

Elevator pit ladder may implement a rung electrical protective device that generates a signal when pressure is applied to any rung 130 of elevator pit ladder 100, and then uses that signal to provoke a change in state in elevator inhibit relay 155 within elevator inhibit device 150. Referring to FIGS. 2 and 3, to construct or otherwise configure the rung electrical protective device, rungs 130 may have, respectively installed thereon, pressure-sensitive strips 132a-132d, representatively referred to herein as pressure-sensitive strip(s) 132. Each pressure-sensitive strip 132 may be constructed or otherwise configured to generate a signal when pressure applied thereto exceeds some threshold, e.g., five (5) pounds per square inch (PSI). When so embodied, a worker stepping on a rung 130 that has pressure-sensitive strip 132 installed thereon will generate a signal that may be applied to elevator inhibit relay 155 to cause a change in state from an operational state to a non-operational state. The operationally-prohibited state may be indicated on indicator lamp 154 and is removed (or returned to an operational state) only when manually reset, i.e., by a worker depressing reset switch 154.

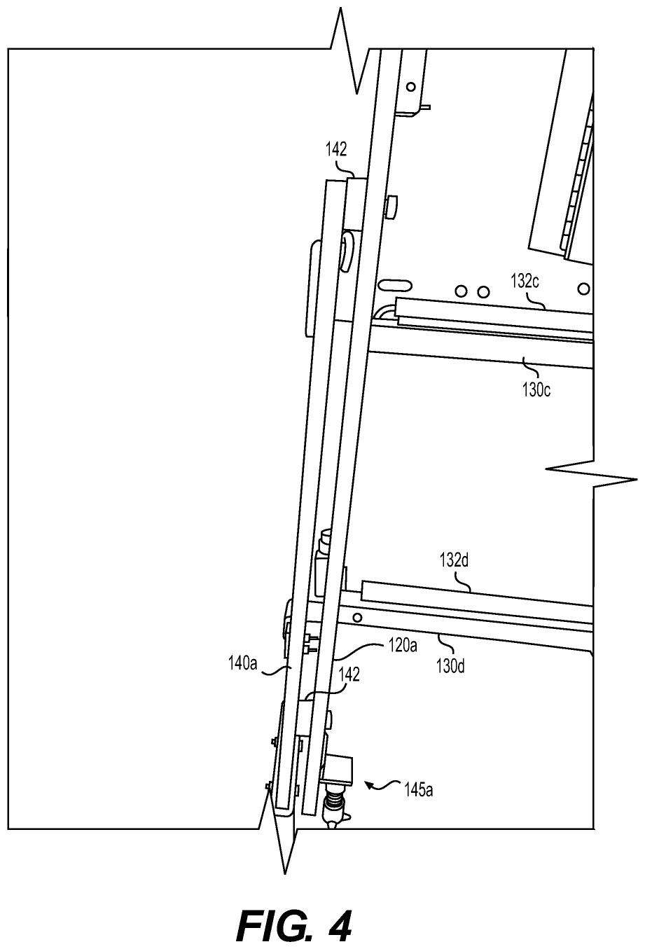

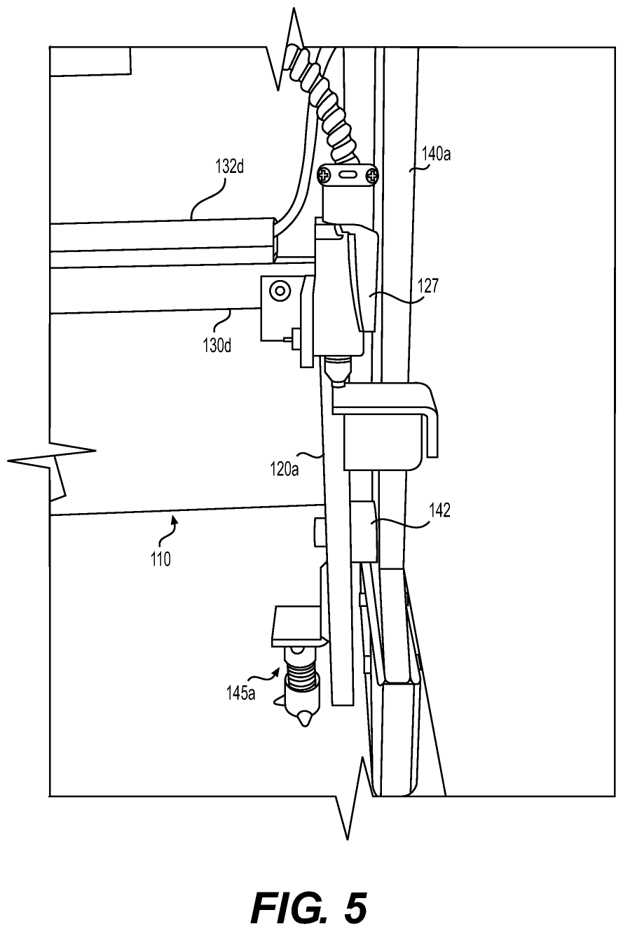

In one embodiment, the electrical protective device mechanism is weight-activated, i.e., the weight of a worker on elevator pit ladder 100 compels the elevator into a non-operational state. To that end, and as illustrated in FIG. 2, elevator pit ladder 100 may be situated in a support frame comprising support frame members 140a-140b, representatively referred to herein as support frame member(s) 140 or as support frame 140, such that each stile 120 is relatively movable over a fixed distance with respect to a corresponding support frame member 140. To that end, as illustrated in more detail in FIGS. 4 and 5, each stile 120 may be mounted to a corresponding support frame member 140 through elongated through-holes and nylon disks 142 and the support frame members 140 may be anchored to the hoistway floor and to the hoistway wall. When so installed, support frame members 140 are rigidly fixed and elevator pit ladder 100 may be movable within support frame 140. The relative movement may be conveyed to a switch (sensor) 127 that is mechanically connected to elevator pit ladder 100 and may be depressed against a landing 126 that is mechanically connected to the support frame members 140. Elevator pit ladder 100 may be held against a bias, such as by biasing mechanisms 145a-145b such that, under no load conditions, elevator pit ladder 100 is elevated above the hoistway floor.

In one embodiment, referring to FIG. 2, an object detection light curtain (herein referred to as “light curtain”) may be constructed over rungs 130 so that an object having a threshold size breaking the light curtain, i.e., activating the light curtain electrical protective device, actively prohibits elevator operation. For example, a light curtain light source component 162s may be mounted at rung level at an upper position on elevator pit ladder 100 and a light curtain receiver component 162r may be mounted at a lower position on elevator pit ladder 100 such that the light from light curtain light source component 162s traverses the space over rungs 130 and terminates at light curtain receiver component 162r. When a threshold criterion is met, such as when a certain percent of light of the light curtain is blocked by an object (meaning the object is a specific size), light curtain receiver component 162r may trigger the elevator inhibit relay (not illustrated) in elevator inhibit device 150, as described above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

1. A safety device for a path that is traversed to enter a region in which danger to an individual is heightened due to operation of a machine, the safety device comprising:
at least one sensor installed along the path to detect the individual thereon, whereby the sensor generates a signal;
a lockout mechanism that compels the machine into a non-operational state in response to receiving the signal from the sensor, the lockout mechanism ensuring the machine remains in the non-operational state when the signal from the sensor is removed therefrom; and
a reset circuit configured to, in response to activation thereof, compel the lockout mechanism to allow the machine into the operational state from the non-operational state.

2. The safety device of claim 1, further comprising a cover that prohibits access to the path and wherein the at least one sensor includes a cover sensor that generates the signal when the cover transitions from a closed configuration, in which access to the path is prohibited by the cover, to an open configuration, in which access to the path is not prohibited by the cover.

3. The safety device of claim 1, further comprising a light curtain interceding access to the path and wherein the at least one sensor includes a light curtain receiver that generates the signal in response to blockage of the light curtain by a prescribed amount.

4. The safety device of claim 1, wherein the at least one sensor includes a pressure sensitive region disposed on the path and configured to generate the signal in response to pressure being applied to the pressure sensitive region.

5. The safety device of claim 1, wherein the machine is an elevator and the path is defined by an elevator pit ladder.

6. A ladder apparatus comprising:
a pair of stiles between which rungs are supported;
a lockout mechanism that compels a machine into a non-operational state in response to a user engaging with the ladder apparatus such that the machine is excluded from an operational state; and
a reset circuit that, in response to activation thereof, compels the machine into the operational state from the non-operational state.

7. The ladder apparatus of claim 6, further comprising a cover that in a closed configuration prohibits access to the rungs and in an open configuration allows access to the rungs, and an electrical protective device mechanism including a cover electrical protective device that compels the machine into the non-operational state in response to the cover transitioning from the closed configuration to the open configuration.

8. The ladder apparatus of claim 7, wherein the cover comprises an inclined flap formed of an upper section thereof so as to fold over an uppermost one of the rungs when the cover is in the closed configuration.

9. The ladder apparatus of claim 6, further comprising a light curtain formed over the rungs and an electrical protective device mechanism includes a light curtain electrical protective device that compels the machine into the non-operational state in response to blockage of the light curtain by a prescribed amount.

10. The ladder apparatus of claim 6, further comprising a pressure sensitive region disposed on at least one of the rungs, and an electrical protective device mechanism includes a rung electrical protective device that compels the machine into the non-operational state in response to pressure being applied to the pressure sensitive region that meets a pressure criterion.

11. The ladder apparatus of claim 10, wherein the pressure criterion is a threshold of five (5) pounds of pressure.

12. The ladder apparatus of claim 6, further comprising a support frame relatively translatable with respect to the stiles, the stiles being upwardly biased and mechanically coupled to a switch that is engaged against the support frame when the stiles have moved downwardly against the bias to meet a distance criterion, and an electrical protective device mechanism includes a weight-activated electrical protective device that compels the machine into the non-operational state in response to relative motion between the stiles and the support frame meets the distance criterion.

13. The ladder apparatus of claim 12, wherein the distance criterion is four (4) inches.

14. The ladder apparatus of claim 6, wherein the machine is an elevator.
